(19) United States
(12) Patent Application Publication
(10) Pub. No.: US 2013/0094889 A1
(43) Pub. Date: Apr. 18, 2013

(54) PRINTING CONTROL METHOD APPLIED TO PRINTING APPARATUS AND RELATED PRINTING APPARATUS

(71) Applicant: Ting-Yuan Cheng, Taipei (TW)

(72) Inventor: Ting-Yuan Cheng, Taipei (TW)

(21) Appl. No.: 13/542,638

(22) Filed: Jul. 5, 2012

(30) Foreign Application Priority Data
Oct. 14, 2011 (TW) 100137346

(51) Int. Cl. B41J 11/42

(52) U.S. Cl. 400/76

(57) ABSTRACT

A method of controlling a printing apparatus is provided. The method is utilized for printing on a plurality of print media, and there are intervals between the print media. The method determines a starting reference point for printing on a print medium. The method includes generating a predicted interval position according to a interval reference position and an period average corresponding to an average width of a single print medium and an average width of a single interval; calculating a difference between a measured interval position and the predicted interval position; generating an error compensation value according to a compensation operation and updating the reference interval position by adjusting the reference interval position according to the error compensation value if the difference value is not greater than a threshold value; and controlling the printing apparatus to print by updating the predicted interval position according to the updated reference interval position.

### BACKGROUND OF THE INVENTION

1. Field of the Invention

The present invention relates generally to printing apparatus, and more particularly, to a method applied to a printing apparatus for positioning edges of the print media, and a printing apparatus having the capability of edge positioning.

2. Description of the Prior Art

Edge detection is used when continuously printing a same content (e.g. label printing) on a huge amount of print media having the same size. Edge detection confirms a position of an edge of each print medium such that a starting reference point of printing can be determined, thereby to ensure a printing result on each print medium are substantially the same. However, these are minor errors between the sizes of each print media due to tolerance. Therefore, the position of the edge of each print medium usually changes. Hence, accurate edge positioning is of great importance during such printing process.

A conventional edge detection arrangement is illustrated in FIG. 1. As shown, an edge detection system 120 includes a light emitter 122 employed for emitting the light, and a light sensor 124 employed for detecting the light emitted by the light emitter 122 to generate a sensed signal. The edge detection system 120 is utilized for detecting leading/trailing edges of each print medium 12 on a print medium sheet 10. The print medium 12 is carried by a thin substrate 13. Generally, the print mediums 12 are supported by the thin substrate 13 and separated each other by an interval 11 therebetween. The intervals 11 are also portions of the thin substrate 13. The light sensor 124 may generate sensed signals with different intensities when the light is incident upon the print mediums 12 or the thin substrate 13, as well as different positions of different materials. When the light is emitted exactly upon the thin substrate 13 (i.e., the interval 11), the sensed signal will have higher intensity due to the high transmittance of the thin substrate 13. In the case of the light is emitted upon the print medium 12, the sensed signal will have lower intensity due to the low transmittance of the print medium 12. Different sensed signals generated in different conditions are illustrated in FIG. 2. Referring to the signal waveform (a), peaks of the sensed signal can be considered as the fact that a center of the interval 11 crosses the light sensor 124 because the center of the interval 11 normally has a highest transmittance. As a result, the position of the center of the interval 11 can be confirmed.

When the position of the center of the interval 11 is confirmed, a threshold value TH for slicing the sensed signal is configured. When the intensity of the sensed signal is lower than the threshold value TH, it is determined that the print medium 12 is currently crossing the light sensor 124. If the intensity of the sensed signal is higher than the threshold value TH, it is determined that the interval 11 is currently crossing the light sensor 124. By doing so, the edge A between the interval 11 and the print medium 12 can be determined, which can be served as a starting reference point of printing. For example, when the edge A is positioned, the printing module can be configured to print from the position that is separated from the edge A by a certain distance. Afterward, each print medium 12 is printed in a same manner.

However, in some cases, this method fails to properly determine the position of the edge A. Please refer to FIG, 1 again. Given that each print medium 12 is embedded with a Radio Frequency Identification (RFID) at the position C, the light sensor 124 may generate abnormal sensed signals due to interferences caused by the RFID, such as the signal waveform (b) shown in FIG. 2. Consequently, the edge A of the print medium 12 cannot be precisely positioned. Furthermore, since such edge detection arrangement does not have any feedback mechanism, it has poor immunity against noises. The sensed signal will be easily interfered with by the noises such that the position of the edge may be mistakenly determined. Apparently, the conventional edge detection arrangement needs to be improved.

### SUMMARY OF THE INVENTION

With this in mind, it is one objective of the present invention to provide a method of edge positioning, which can overcome the problems encountered by the conventional art.

It is one objective of the present invention to provide an edge positioning method and a printing apparatus using the edge positioning method, which predicts the position of the center of the interval at first. Then, the edge is positioned according to the interval position and the width of the interval. Since the present invention does not directly measure the intensity of the sensed signal with respect to each position of the print medium. The result of the edge positioning will not be affected by material changing of the print medium (e.g. embedded RFID).

It is another objective of the present invention to provide an edge positioning method and a printing apparatus using the edge positioning method, which includes a noise reduction mechanism based on the phase lock loop technique in order to reduce noises in the sensing system. As a result, the interferences with sensed signal caused by the noises can be avoided.

According to a first aspect of the present invention, a method of controlling a printing apparatus is provided. The printing apparatus prints on a plurality of print media, and the print media has a plurality of intervals therebetween. The method determines a starting reference point of printing for a print medium, which comprises: generating a predictive interval position according to an interval reference position, an period average value of an average interval corresponding to a single print medium, and an average interval corresponding to a single interval; calculating a difference between a measured interval position and the predictive interval position; determining whether the difference is greater than a threshold value; performing a compensation operation to generate an error compensation value and adjusting the interval reference position to update the interval reference position according to the error compensation value if the difference is not greater than the threshold value; and updating the predictive interval position according to the updated interval reference position to determine the starting point of printing, thereby to control the printing apparatus to print on the print medium.

According to a second aspect of the present invention, a printing apparatus for printing on a plurality of print media is provided, wherein the print media has a plurality of intervals therebetween. The printing apparatus includes: a printing module, a sensing module, and a printing controlling module. The printing module is utilized for printing on the print media. The sensing module is utilized for generating a sensed signal. The printing controlling module is coupled to the printing module and the sensing module, and for referring to the sensed signal to determine a starting reference point of printing for a print medium, thereby controlling the printing module to print. The printing controlling module performs steps of : generating a predictive interval position according to an interval reference position and an period average value of an average interval corresponding to a single print medium and an average interval corresponding to a single interval; calculate a difference between a measured interval position and the predictive interval position; determining whether the difference is greater than a threshold value; performing a compensation operation to generate an error compensation value and adjusting the interval reference position to update the interval reference position according to the error compensation value if the difference is not greater than the threshold value; and updating the predictive interval position according to the updated interval reference position to determine the starting point of printing, thereby to control the printing apparatus to print on the print medium.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a drawing illustrating a conventional edge detection arrangement.

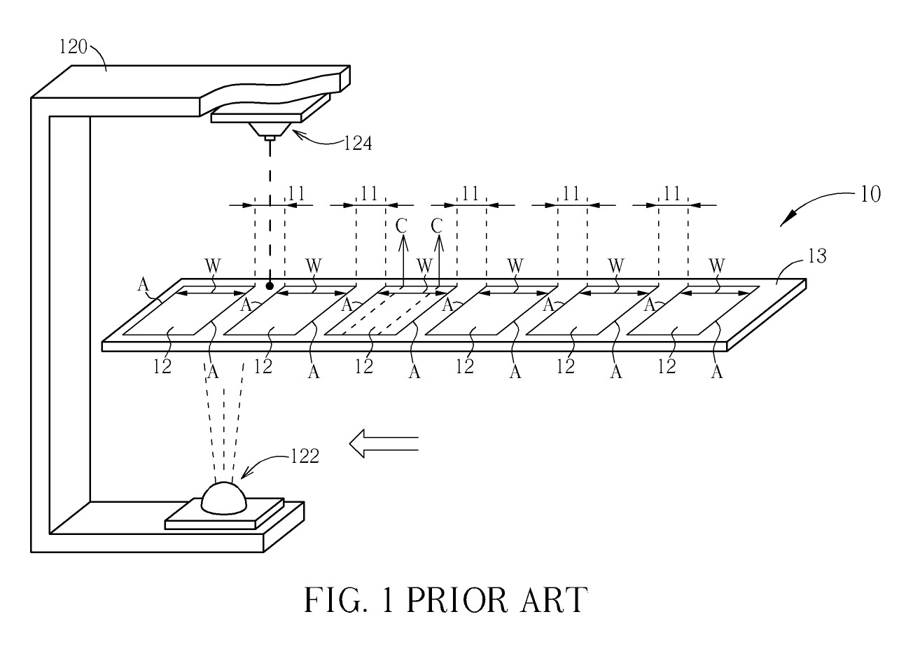

FIG. 2 is a drawing illustrating sensed signals that are generated based on the conventional edge detection arrangement.

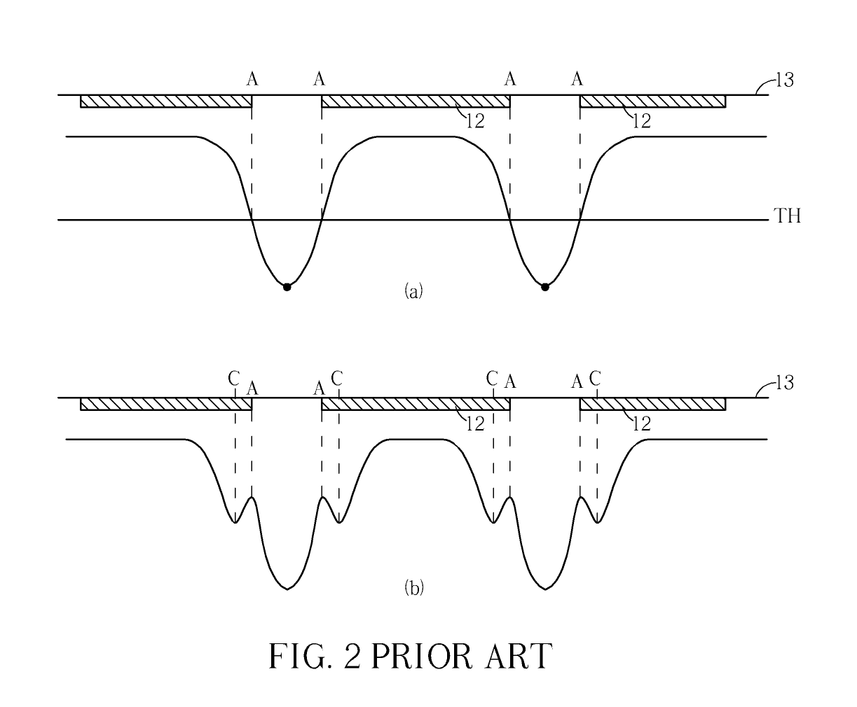

FIG. 3 is a block diagram illustrating a printing apparatus according to an embodiment of the present invention.

FIG. 4 is a flow chart of a printing control method according to one embodiment of the present invention.

FIG. 5 is a block diagram of a compensation module according to one embodiment of the present invention.

### DETAILED DESCRIPTION

Certain terms are used throughout the following descriptions and claims to refer to particular system components. As one skilled in the art will appreciate, manufacturers may refer to a component by different names. This document does not intend to distinguish between components that differ in name but not differ in functionality. In the following discussion and in the claims, the terms “include”, “including”, “comprise”, and “comprising” are used in an open-ended fashion, and thus should be interpreted to mean “including, but not limited to . . . ” The terms “couple” and “coupled” are intended to mean either an indirect or a direct electrical connection. Thus, if a first device couples to a second device, that connection may be through a direct electrical connection, or through an indirect electrical connection via other devices and connections.

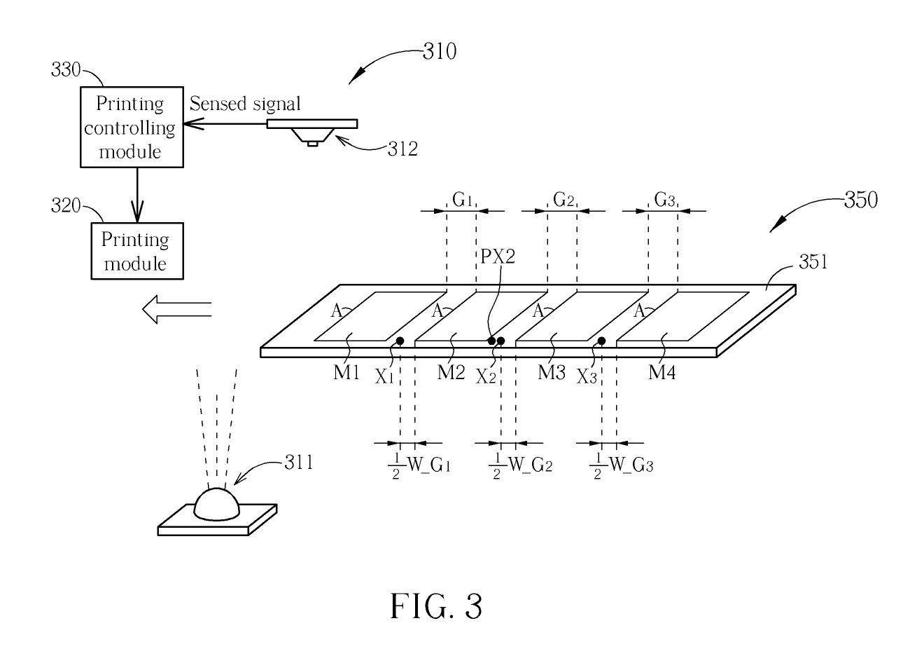

With reference to FIG. 3, a diagram of a printing apparatus is depicted according to one exemplary embodiment of the present invention. As depicted, a printing apparatus 300 includes a sensing module 310, a printing module 320, and a printing controlling module 330. The sensing module 310 comprises a light emitter 311 and a light sensor 312. A plurality of print media M1˜M4 of the print medium sheet 350 are printed in sequence by the printing module 320 controlled by the printing controlling module 330 based on the method of the present invention. The print medium sheet 350 includes a thin substrate 351 and the print media M1˜M4. The print media M1˜M4 are attached to the thin substrate 351. There are intervals G1˜G3 respectively between any two of the print media M1˜M4. When the print media M1˜M4 with the lower transmittance pass across the sensing module 310, the sensed signal with respect to the print media M1˜M4 will have a lower intensity. When the intervals G1˜G3 with the higher transmittance pass across the sensing module 310, the sensed signal with respect to the intervals G1˜G3 will have a higher intensity. For the purpose of uniform and accurate contents to be printed onto each of the print medium M1˜M4 by the printing module 320, it is necessary for the printing controlling module 330 to provide the printing module 320 with accurate starting reference points of printing (namely, the position A of the edge of each print medium M1˜M4). To eliminate drawbacks of those known edge detection methods, the present invention predicts a position of a center X of the interval followed by determining the position of the edge A according to the predicted position of the center X. The position of the edge A can be acquired by adding half a width of the interval (i.e., ½*W_Gi) to the position Xi of the center. Please note that this invention is not limited in scope to the number of the print media and the intervals. The specific numbers of the print media and intervals mentioned in the specification are intended for illustrative purposes.

Afterward, the position of the edge A of the each print medium is acquired in the same manner. To derive the position of edge of each print medium, it is necessary to predict a position X(i+1) of a following center from a position X(1) of a preceding center. There is a relationship between the position of the following center and the position of the preceding center, which can be expressed as below:

P(i+1)=P(i)+N+W_{—}G(i+1)+W_{—}M(i+1)

Wherein P(i) represents the position of the preceding center; P(i+1) represents the position of the following center; W_Gi represents a specified width of a single interval; W_Mi represents a specified width of a single print medium; and N represents an error caused by noises.

In the ideal case, N should be very close to zero, W_Gi and W_Mi should maintain consistency. However, there are a variety of factors in the printing apparatus 300 that may introduce noises, thereby interfering with the sensed signal. Additionally, errors in the actual widths of M1˜M4 and in the actual widths of the intervals G1˜G3 due to tolerance may make the positioning of the centers of the intervals very uncertain. The average values of W_Gi and W_Mi may be acquired to reduce influence from the errors due to tolerance. The actual widths of each interval and each print medium are measured and averaged by the sensing module 310 for the reduction of influence from the errors caused by tolerance. As result, an average width of print mediums M1˜M4 which represents an average interval corresponding to a single print medium is calculated, and an average width of intervals G1˜G3 which represents an average interval corresponding to a single interval is calculated as well. However, it is still necessary to reduce the error caused by noise N with other methods, thus, the present invention utilizes PLL technique to reduce the random and uncertain noise.

Please note that the interval position hereinafter may be a position with respect to a center of the interval rather than an absolute position of the center of the interval, but the present invention is not limited to aforementioned.

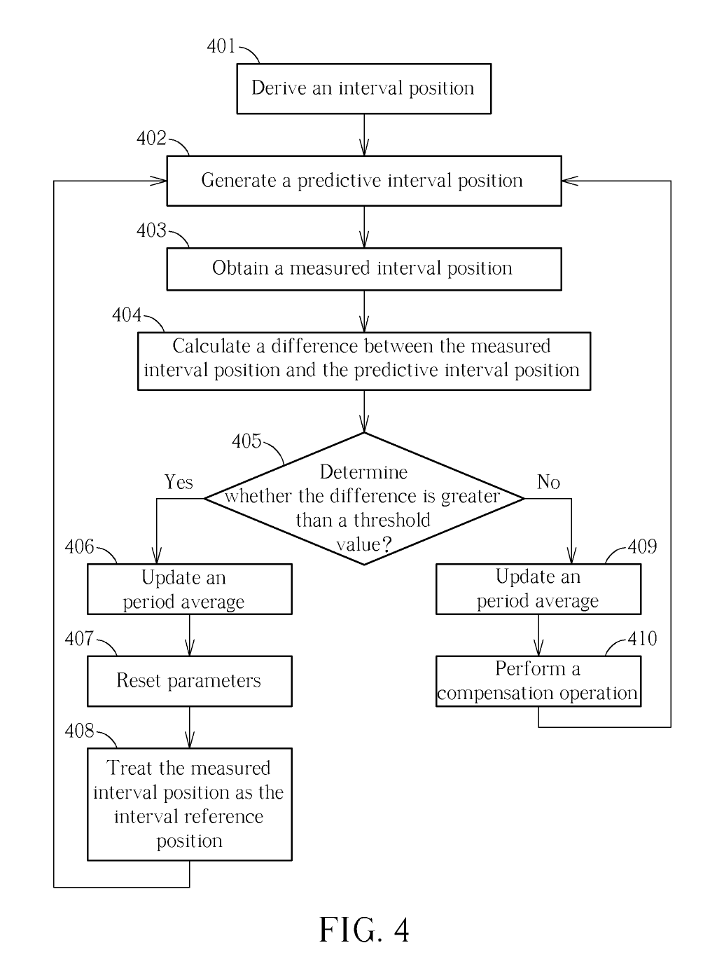

Please refer to FIG. 3 in conjunction with FIG. 4. FIG. 4 illustrates a flow chart of an embodiment of the present invention. The flow starts at Step 401, where an interval position (e.g. X1) is derived. The interval position may be derived by detecting a peak of a sensed signal generated by the sensing module 310. Then, the flow goes to Step 402, where a predictive interval position (e.g. PX2) is generated. If it is the first time to enter Step 402, the predictive interval position is calculated according to a period average and the interval position obtained in Step 401, wherein the period average is a sum of an average interval corresponding to a single interval and an average interval corresponding to a single print medium. When Step 402 is entered for the first time, a specified width W_Mi of the print medium serves as the average interval corresponding to a single print medium while a specified width W_Gi of the interval serves as the average interval corresponding to a single interval. If Step 402 is entered again, the predictive interval position will be calculated by an interval reference position and the period average. The interval reference position will be illustrated later. When the predictive interval position is determined, the printing apparatus 300 will proceed the printing of the next print medium M2 (wherein the predictive interval position PX2 and half a width of the interval (½*W_G2) is used to obtain the starting reference point of painting). After the printing is completed, a next interval G2 will pass across the sensing module 310, the peak of the sensed signal generated by the sensing module 310 can determine an actual measured interval position (e.g. X2) (Step 403). Afterward, the flow goes to Step 404, a difference between the measured interval position and the predictive interval position (PX2) is calculated and may be used to determine whether the predictive interval position (PX2) that is predicatively generated based on the method of the present invention is accurate or needs to be corrected. Hence, the flow goes to Step 405, in which it is determined whether the difference is greater than a threshold value.

In the case of the difference greater than the threshold value in Step 405, the flow enters a left loop of the flow shown in FIG. 4. This means the predictive interval position (PX2) and the measured interval position (X2) are quite different and have a significant error therebetween. That a print medium M2 gets stuck in the printing mechanism of the printing module 320 is one of mostly factors result in the significant error. Unless the abnormality is solved, the present invention will not activate the noise reduction mechanism since the error is not caused by the noises. At the first step of this loop, Step 406, the period average is updated, thereby to generate a new predictive interval position. The concept of updating the period average is similar to moving average method, wherein the width W_M2 of the next print medium M2 and the width W_G2 of the next interval G2 will be taken into calculation of the period average. That is, the width W_M2 of the next print medium M2 is averaged with the specified width W_Mi to update the average interval corresponding to a single print medium. In addition, the width W_G2 of the next interval G2 is averaged with specified width W_Gi to update the average interval corresponding to a single interval. As a result, the period average, which is the sum of the above two average intervals, will be therefore updated. This step will be entered again when the edge of a next print medium M3 needs to be positioned. In the same manner, the width W_M3 of the print medium M3 and the width W_G3 of the interval G3 will also be used to update the period average in the same manner. Then, Step 407 is entered, where parameters for the compensation operation is reset (which will be illustrated later). At last, the flow goes to Step 408, in which the measured interval position will be treated as the interval reference position. Therefore, when the flow goes back to Step 402, the predictive interval position will be acquired by summing the interval reference position and the period average. From the above description, when the flow goes from Step 406 to Step 408, and then goes back to Step 402, in which the predictive interval position is re-generated to obtain the interval position of a next interval G3, no any mechanism is utilized to reduce the noise. This is because the abnormality here will cause a huge error, which cannot be eliminated by the noise reduction mechanism of the present invention.

In the case of the difference less than the threshold value in Step 405, the flow goes to the right loop, and it means that the difference between the predictive interval position (PX2) and an interval position (X2) derived by practically measuring is not very different. The error therebetween can be eliminated and compensated by the noise reduction mechanism of the present invention based on the PLL technique. Although the moving average method averages the actual widths of the print medium and of the interval with the specified widths of the print medium and the interval, which reducing the error due to tolerance to a certain extent. However, the effect of the moving average method is subject to enough sampling number. Therefore, the compensation operation based on PLL technique will do a favor for reducing the error caused by tolerance. The principles and operations regarding Step 409 of the right loop are similar to those of Step 406 as aforementioned, so detailed descriptions are omitted here for the sake of brevity. Afterward, Step 410 is entered and a compensation operation is performed.

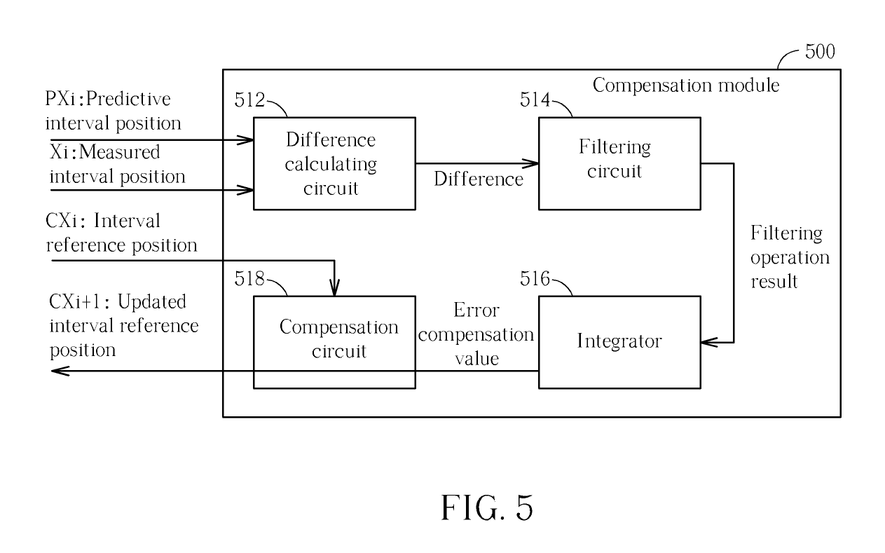

An illustration about the compensation operation can be retained according to a block diagram shown in FIG. 5. As shown, a compensation module 500 is utilized for performing the compensation operation. The compensation module includes a difference calculating circuit 512, a filtering circuit 514, an integrator 516, and a compensation circuit 518. The difference calculating circuit 512 calculates a difference between the measured interval position (Xi) and the predictive interval position (PXi). Accordingly, the filtering circuit 514 performs a filtering operation upon the difference to generate a filtering operation result. The integrator 516 performs an integration operation upon the filtering operation result to generate an error compensation value. As mentioned above, although the noises are random, these random noises can be eliminated with each other by the integrator 516 performing the integration operations on the difference for a long period of time. Afterward, the compensation circuit 518 adjusts the interval reference position (CXi) to update interval reference position (CXi+1) according to the error compensation value. In should be noted that the compensation module 500 are illustrated as being implemented with hardware circuits in the above descriptions. However, in other embodiments, it is also possible to implement the compensation module 500 with software and/or a combination of hardware and software. Additionally, the compensation module 500 could be incorporated into the printing controlling module 330.

A result of the above-mentioned compensation operation is used to compensate the interval reference position, thereby to reduce the difference between the predictive interval position (Pxi) and the measured interval position (Xi). In other words, the compensation operation is able to compensate the errors due to tolerance as well as the errors due to the noises. After the right loop has been entered for several times, the predictive interval position will become more and more accurate. Nevertheless, once the above-mentioned abnormality occurs, the flow will jump to the left loop again. At this time, the accumulated result from previous compensation operations is meaningless (i.e., the integration result of the integrator 516, and/or parameters for configuring the integrator 516 and the filtering circuit 514). In view of this, the parameters for configuring the compensation module 500 will be reset (Step 407).

In another exemplary embodiment of the present invention, in order to prevent from entering the left loop which is not caused by the abnormality of the printing apparatus, Step 408 will not treat the measured interval position as the interval reference position but instead a sum of the measured interval position and a compensation amount will be used to update the interval reference position. As a result, the difference caused by the noises in the system will be easily convergent, thereby to make the flow go back to the right loop more easily in order to continue the noise reduction.

In conclusion, the present invention utilizes the compensation operation and the prediction of the interval position to precisely position the edge of the print medium such that the problems encountered by the conventional art can be overcome.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of controlling a printing apparatus, the printing apparatus printing on a plurality of print media, the print media with a plurality of intervals therebetween, the method determining a starting reference point of printing for a print medium, comprising:
generating a predictive interval position according to an interval reference position, an period average of an average interval corresponding to a single print medium and an average interval corresponding to a single interval;
calculating a difference between a measured interval position and the predictive interval position;
determining whether the difference is greater than a threshold value;
performing a compensation operation to generate an error compensation value and adjusting the interval reference position to update the interval reference position according to the error compensation value if the difference is not greater than the threshold value; and
updating the predictive interval position according to the updated interval reference position to determine the starting point of printing, thereby to control the printing apparatus to print on the print medium.

2. The method of claim 1, wherein the step of performing the compensation operation to generate the error compensation value comprises:
performing a filtering operation on the difference to generate a filtering operation result; and
integrating the filtering operation result to generate the error compensation value.

3. The method of claim 1, further comprising:
updating the period average according to a width of a specific print medium and a width of a specific interval if the difference is not grater than the threshold value.

4. The method of claim 3, wherein the specific print medium is followed by the specific interval, the interval reference position corresponds to a position of a center of a first interval in the intervals, the specific interval is a second interval in the intervals, and both the first interval and the second interval are neighboring and at two sides of the specific print medium.

5. The method of claim 1, further comprising:
updating the interval reference position according to at least the measured interval position if the difference is greater than the threshold value.

6. The method of claim 5, wherein the step of updating the interval reference position according to at least the measured interval position comprises:
updating the interval reference position according to a sum of the measured interval position and a predetermined compensation amount.

7. The method of claim 5, further comprising:
updating the period average according to a width of a specific print medium and a width of a specific interval if the difference is greater than the threshold value.

8. The method of claim 7, wherein the specific print medium is followed by the specific interval, the interval reference position corresponds to a position of a center of a first interval in the intervals, the specific interval is a second interval in the intervals, and the first interval and the second interval are neighboring and at two sides of the specific print medium.

9. A printing apparatus for printing on a plurality of print media, the print media with a plurality of intervals therebetween, comprising:
a printing module, for printing on the print media;
a sensing module, for generating a sensed signal; and
a printing controlling module, coupled to the printing module and the sensing module and configured for referring to the sensed signal to determine a starting reference point of printing for a print medium, thereby controlling the printing module to print, the printing controlling module performing steps of :
generating a predictive interval position according to a interval reference position and an period average of an average interval corresponding to a single print medium and an average interval corresponding to a single interval;
calculating a difference between a measured interval position and the predictive interval position;
determining whether the difference is greater than a threshold value;
performing a compensation operation to generate an error compensation value and adjusting the interval reference position to update the interval reference position according to the error compensation value if the difference is not greater than the threshold value; and
updating the predictive interval position according to the updated interval reference position to determine the starting point of printing, thereby to control the printing apparatus to print on the print medium.

10. The printing apparatus of claim 9, wherein the printing controlling module has a compensation module, and the compensation module comprises:
a difference calculating circuit, for calculating a difference between the measured interval position and the predictive interval position;
a filtering circuit, coupled to the difference calculating circuit and configured for performing a filtering operation on the difference to generate a filtering operation result;
an integrator, coupled to the filtering circuit and configured for performing an integration operation on the filtering operation result to generate the error compensation value; and
a compensation circuit, coupled to the integrator and configured for using the error compensation value to compensate the interval reference position to update the interval reference position.

11. The printing apparatus of claim 9, wherein the printing controlling module updates the period average according to a width of a specific print medium and a width of a specific interval if the difference is not grater than the threshold value.

12. The printing apparatus of claim 11, wherein the specific print medium is followed by the specific interval, the interval reference position corresponds to a position of a center of a first interval in the intervals, the specific interval is a second interval in the intervals, and both the first interval and the second interval are neighboring and at two sides of the specific print medium.

13. The printing apparatus of claim 9, wherein the printing controlling module updates the interval reference position according to at least the measured interval position if the difference is greater than the threshold value.

14. The printing apparatus of claim 13, wherein the printing controlling module updates the interval reference position according to a sum of the measured interval position and a predetermined compensation amount.

15. The printing apparatus of claim 13, wherein the printing controlling module updates the period average according to a width of a specific print medium and a width of a specific interval if the difference is greater than the threshold value.

16. The printing apparatus of claim 9, wherein the specific print medium is followed by the specific interval, the interval reference position corresponds to a position of a center of a first interval in the intervals, the specific interval is a second interval in the intervals, and the first interval and the second interval are neighboring and at two sides of the specific print medium.
